(19) United States
(12) Patent Application Publication
(10) Pub. No.: US 2013/0268334 A1
(43) Pub. Date: Oct. 10, 2013

(54) CREDIT CARD HAVING REIMBURSEMENT FOR BENEFITS

(71) Applicant: Donald SPECTOR, New York, NY (US)

(72) Inventor: Donald SPECTOR, New York, NY (US)

(21) Appl. No.: 13/910,540

(22) Filed: Jun. 5, 2013

Related U.S. Application Data
(63) Continuation-in-part of application No. 13/863,585, filed on Apr. 16, 2013.
Application No. 13/863,585 is a continuation-in-part of application No. 12/388,248, filed on Feb. 18, 2009.
(60) Provisional application No. 61/145,752, filed on Jan. 20, 2009.
(60) Provisional application No. 61/037,611, filed on Mar. 18, 2008.

(51) Int. Cl. G06Q 20/10

(52) U.S. Cl. CPC G06Q 20/102
USPC 705/14.17

(57) ABSTRACT

An improved computerized method for provides credit card services by a card issuer. A cardholder has an account with the card issuer and the method includes storing, in association with the account, data associated with the cardholder's benefits. It also includes processing incoming merchant charges to be posted to the account to flag any charge identified as covered by the benefits and to store such charge as flagged. Finally it includes deferring billing of any flagged charge, pending settlement of such flagged charge under an arrangement with the benefit provider.

### CROSS REFERENCE TO RELATED APPLICATIONS

The present application is a continuation-in-part of U.S. patent application Ser. No. 13/863,585 filed on Apr. 16, 2013, which in turn is a continuation-in-part of U.S. patent application Ser. No. 12/388,248 filed on Feb. 18, 2009, which claims the benefit of priority under 35 U.S.C. §119(e) from U.S. Provisional Patent Application Ser. No. 61/145,752 filed Jan. 20, 2009, and U.S. Provisional Patent Application Ser. No. 61/037,611 filed Mar. 18, 2008. Each of these related applications is hereby incorporated herein by reference in its entirety.

### BACKGROUND OF THE INVENTION

1. Field of the Invention

The present invention relates to computerized systems and methods, and more particularly to computerized systems and methods for credit card services, particularly as applied to payments for mortgages and other expenses which may be reimbursed through a government or private benefit plan.

2. The Prior Art

People sometimes find themselves in situations where pay for items which are really covered, either fully or partially, by a private or government-based benefit plan. For example, veterans are often entitled to benefits such as reduced mortgage rates, discounts at sporting events and other benefits.

Computerized methods and systems for providing credit card services are well known in the art. FIG. 1 illustrates how credit cards are commonly employed in transactions. Typically at least four parties are involved in a transaction involving a credit card purchase: the cardholder, the merchant, the merchant's bank, and the card issuing bank. The cardholder makes the purchase (obtaining the goods in process 105), signing a credit card charge (in process 101), which the merchant forwards to the merchant's bank, usually in a batch process (106). The merchant's bank in turn (in process 110) pays the merchant on the charge (the merchant receiving the funds in process 111) and (in process 107) forwards the charge to the card issuing bank (which receives the batch in process 108). The card issuing bank (in process 109) pays the merchant bank and debits the cardholder's credit account. The cardholder (in process 112) is billed periodically, commonly monthly, by the card issuing bank, and (in process 114) pays the card issuing bank (which receives the funds credits the account in process 115). Typically the amount received by the merchant from the merchant's bank reflects a discount for handling by the merchant's bank of its portion of the transaction, and the amount received by the merchant's bank from the card issuing bank reflects another discount for the card issuing bank's participation in the transaction.

When the charge is viewed by the merchant as substantial, the merchant may seek (in process 102) and obtain (in process 104) approval from the card issuing bank (granted in process 103) to enter into the charge transaction with the customer, and such approval provides enhanced protection against the risk that the card issuing bank will refuse to honor the cardholder's charge.

The processes described in connection with FIG. 1 are explicated and exemplified in various aspects in references including (i) a description on the web site of Bank of America at http://www.bankofamerica.com/small_business/merchant_card_processin g/inde-x.cfm?template=card_processingbasics as viewed on Feb. 6, 2009 at 7:07 p.m. EST; (ii) the Wikipedia article on “Credit card” at http://en.wikipedia.org/wiki/Creditcard as viewed on Feb. 6, 2009 at 7:13 p.m. EST; U.S. Pat. No. 6,606,205 entitled “Credit Card Billing Method and System”; (iv) Chakravorti et al., “A Study of the Interrelated Bilateral Transactions in Credit Card Networks,” Federal Reserve Bank of Chicago, 2001, available at http://papers.ssrn.com/sol3/papers.cfm?abstractid=294510 on Feb. 7, 2009; (iv) Hunt, “An Introduction to the Economics of Payment Card Networks,” Federal Reserve Bank of Philadelphia, 2003, available at www.philadelphiafed.org/research-and-data/publications/working-pape rs/200-3/wp03-10.pdf on Feb. 7, 2009; “Credit Card Processing--Glossary of Terms,” available at http://www.fasttransactonline.com/creditcardglossary.htm on Feb. 7, 2009 at 12:53 p.m. EST; U.S. Pat. No. 3,852,571 entitled “System of Transferal of Funds”; U.S. Pat. No. 4,172,552, entitled “Credit Card Processing System”; and U.S. Pat. No. 5,056,019 entitled “Automated Purchase Reward Accounting System and Method.” Each of these references is hereby incorporated herein by reference in its entirety.

### SUMMARY OF THE INVENTION

The present invention is a method employing computerized processing of a stream of incoming charges to be posted and stored as debits to a cardholder's account and to generate a bill of the posted charges on a periodic basis to the cardholder's account. The cardholder then pays the card issuer at least the minimum monthly amount required by the cardholder.

In a first embodiment of the invention there is provided an improved computerized method for providing credit card services by a card issuer. In the present invention, the cardholder provides the card issuer with a variety of personal information, such as qualifications for government benefit programs, as well as the cardholder's financial information, such as debts, income, assets and employment history. The card issuer maintains a database of benefits that various types of individuals are eligible for. For example, there would be a database for veterans, a database for retired government employees, and any other category of persons that might be eligible for various benefit programs. The various benefits are stored in this database and can be linked with a cardholder if the cardholder is qualified to receive the benefits.

The card issuer processes incoming charges to be posted to the account to flag any charge identified as possibly being linked to a benefit and to store such charge as flagged. Finally it includes deferring billing of any flagged charge, pending settlement of such flagged charge under an arrangement with the benefit provider, whereby the card issuer files a claim with the benefit provider for the flagged amount. The credit card according to the invention does not require payment from the patient until the charge has been reviewed and either denied or paid for by the benefit provider.

In a further related embodiment, settlement of each flagged charge comprises using a settlement computer process and crediting of the account of the constituent with an amount corresponding to such flagged charge.

In a further related embodiment, the method further includes seeking out and processing additional charges that are incurred as a result of a charge made by the card holder. This type of situation occurs when the cardholder uses the credit card to purchase a home. Along with the purchase of a home, there are various other fees that occur, such as closing costs, realtor commissions, homeowner's insurance, homeowner association dues, and various other charges. In one embodiment of the invention, the cardholder, who may be a veteran, contacts the card issuer to obtain prior approval for the purchase of a home. The card issuer maintains a database for veterans benefits as well as having access to information about the home to be purchased. The card issuer calculates the total cost of the home and all of the associated fees, and creates a monthly payment plan, in the manner of a mortgage. If the monthly payment is within an acceptable amount determined by the cardholder, the cardholder approves of the purchase and it goes through. In processing the purchase, the cardholder then obtains homeowner's insurance, title insurance and any other insurance required for the purchase, and rolls this amount into the monthly payments required from the cardholder.

In the case of a veteran, the VA guarantees the down payment, so the card issuer processes the charge as a VA loan, knowing that if the cardholder defaults, the government will at least guarantee the 20% down payment. The card issuer maintains this information in the database, so that the down payment is also rolled into the monthly fee and is not required to be paid up front by the cardholder. The closing costs are also rolled into the monthly fee. Thus, the credit card issuer holds the mortgage, as well as covers all auxiliary fees associated with a home purchase. The cardholder merely has to make the minimum monthly payment on the card to maintain the home. The card issuer then also takes care of making the yearly insurance and tax payments, as well as the homeowner's association dues an any other associated charges.

The computerized system of the card issuer has an automated qualification process, whereby the income and benefit status of the cardholder are used to calculate the maximum monthly payment available to the cardholder. Once the cardholder finds a home to purchase, the cost of the home and other associated fees and taxes are processed into a monthly payment plan. If the actual monthly payments are at or below the maximum monthly payment, the card issuer approves of the sale and the sale can proceed. The cardholder then pays for the house with the credit card, and the card issuer pays the seller in full. The card issuer then contracts for homeowner's insurance, registers for tax bills and all other fees that are coordinated with ownership of the property. This way, the cardholder simply needs to pay a single monthly bill in order to have all of the home-related expenses paid. The cardholder keeps a security interest in the property in case the cardholder defaults.

The present invention does not necessarily require the use of a physical credit card, but can be performed using communication of the cardholder's data and purchases directly to the card issuer computer system via other methods, such as via a smartphone. The terms “credit card”, “cardholder” and “card issuer” as used in this application do not require the use of an actual card in order to complete the transaction.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 is a diagram illustrating how credit cards are commonly employed in transactions.

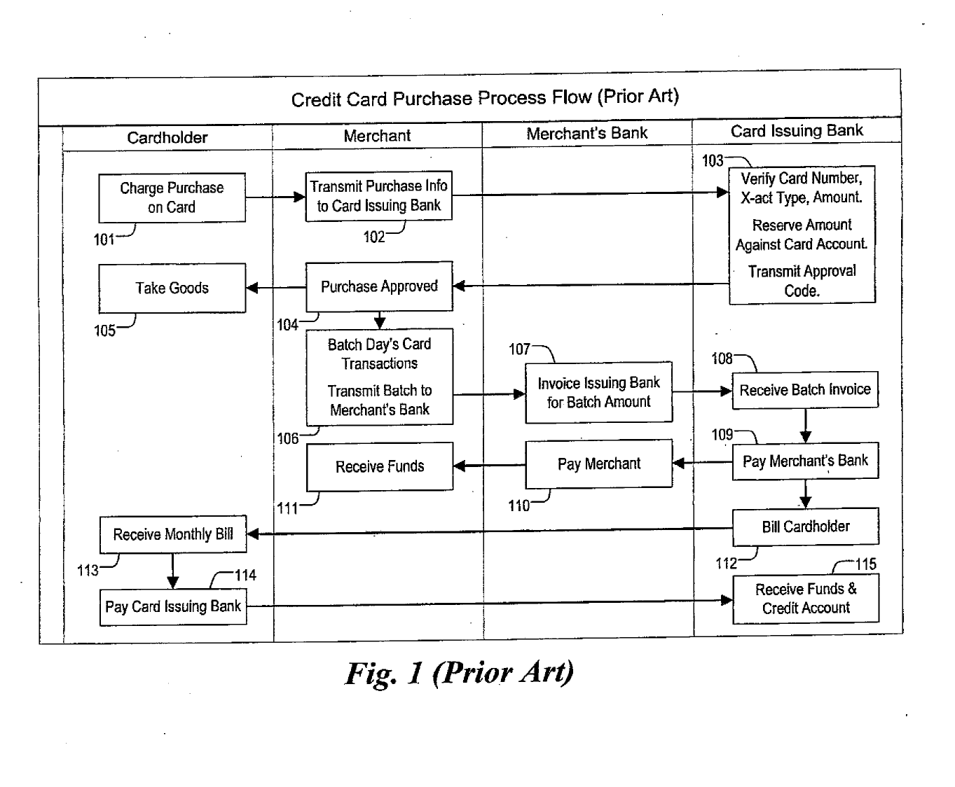

FIG. 2 is a block diagram of a system according to the invention for providing mortgage financing to a cardholder.

FIG. 3 is a flow diagram illustrating use of the credit card for purchases that are partially reimbursed via a benefit plan.

FIG. 4 is a flow diagram illustrating the process for purchasing a home using the credit card of the invention.

### DETAILED DESCRIPTION OF THE PREFERRED EMBODIMENTS

Definitions. As used in this description and the accompanying claims, the following terms shall have the meanings indicated, unless the context otherwise requires:

A “card issuer” is an entity that is in the business of providing credit card services. A card issuer may be a bank, and alternatively or in addition may be a mortgage company or an affiliate of a mortgage company.

Each of the terms “debit”, “credit”, and “bill”, used herein as either a noun or a verb, refers not simply to an accounting concept but more specifically to a computerized implementation of the corresponding accounting concept. In particular, as indicated by references above including U.S. Pat. No. 6,606,205, U.S. Pat. No. 4,172,552, and U.S. Pat. No. 5,056,019, delivery of credit card services is heavily computerized, and it has long been within the skill of the art to employ computer processes to cause an amount to be debited or credited to a specific account and for a specific account to be billed.

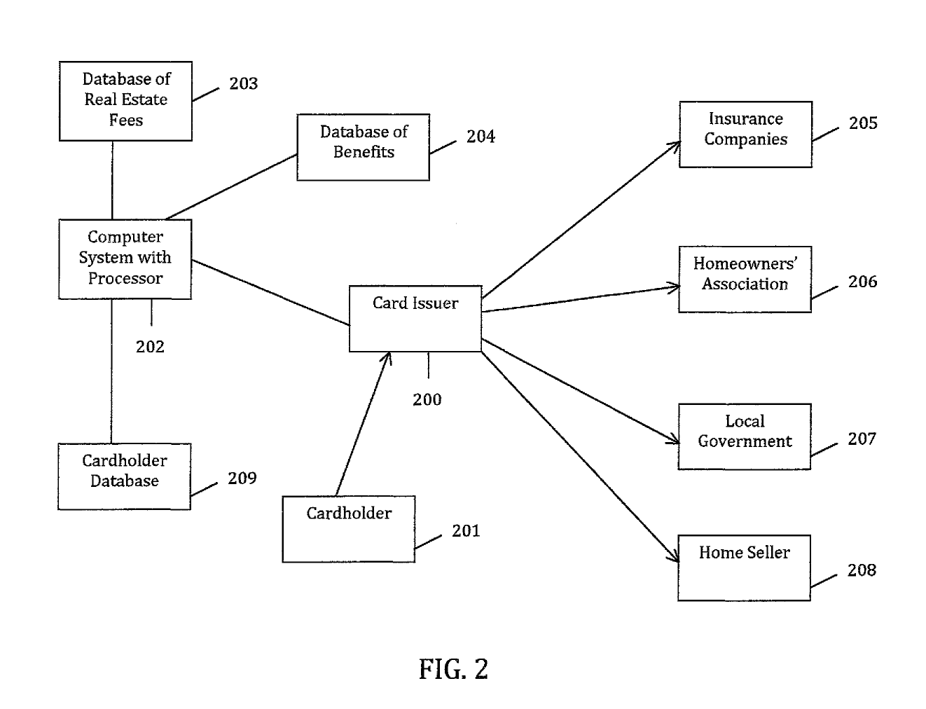

FIG. 2 shows a block diagram of the credit card network in which the present invention operates. In the present invention, card issuer 200 issues a credit card to cardholder 201, who provides card issuer 200 with personal and financial information to be stored in cardholder database 209, which is connected to a computer system with a processor 202. Processor 202 is also connected to a database of benefits 204, which catalogues various benefits available to certain cardholders. Processor 202 compares the information from cardholder 201 with database 204 to flag any benefits that cardholder 201 is eligible for. Any charges made by cardholder 201 that might be reduced due to eligibility for benefits is flagged pending a submission of a benefit claim or other process. Card issuer 200 can submit the benefit claim to the relevant agency and await reimbursement from the agency before billing the cardholder.

The system of the present invention is especially useful when used for the purchase of a home. Card issuer 200 also keeps a database of home prices and real estate fees, to help cardholder 201 to determine eligibility to purchase a home using the credit card. Once cardholder 201 uses the credit card to pay for a home, card issuer sends payments directly to home seller 208, Insurance company 205, Homeowners Association 206 and Local Government 207 for the real estate taxes. Cardholder 201 merely pays the monthly bill send to cardholder 201 by card issuer 200.

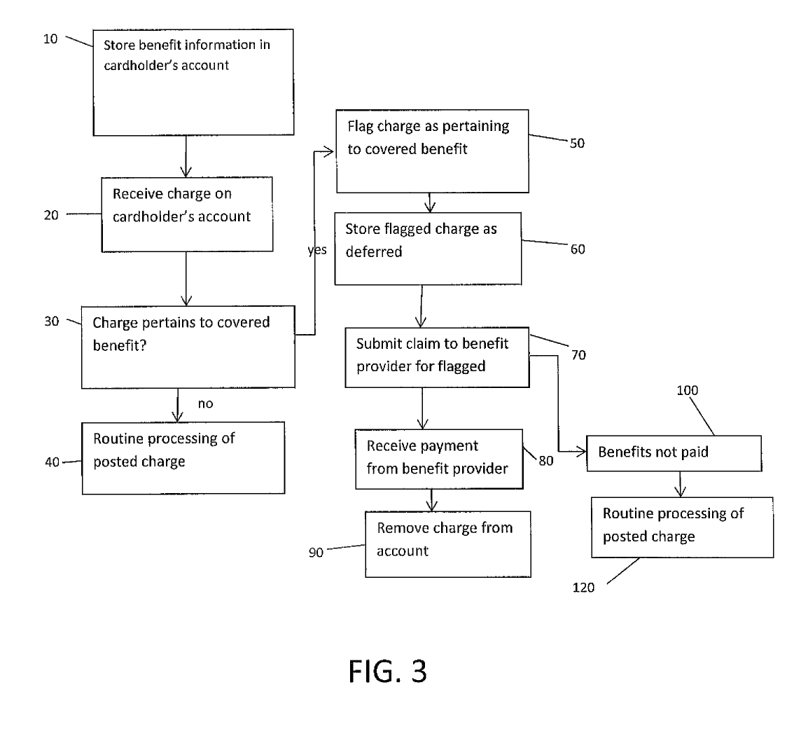

FIG. 3 is a flow chart of a computerized method for providing healthcare credit card services by a card issuer, in accordance with an embodiment of the present invention. In process 10, information related to benefits of the cardholder is stored in card issuer database 201B in association with the cardholder's credit card account.

In operation, the information stored by the card issuer will include the cardholder's name, address, date of birth, social security number and eligibility for government or private benefits, income, employment history and any other information.

In process 20, card issuer computer system 201A receives a charge on the cardholder's credit card account. This transaction is received by card issuer computer system 202.

In process 30, a decision branch in the card issuer software of the computer system 202 determines whether the transaction to the cardholder's credit card account pertains to a possibly covered benefit based on a comparison of the transaction information received in process 30 to the data regarding benefits available to the cardholder. If decision branch process 30 determines that the charge to the cardholder's account does not pertain to a covered benefit, then, in process 40, the charge is posted to the card account as a current debit. In process 40, the charge is processed and billed as a routine credit card charge.

If decision branch process 30 determines that the charge to the cardholder's account does pertain to a reimbursed service, in process 50, the charge transaction is flagged as pertaining to an reimbursed service. Zn process 60, the flagged charge is stored as a debit in card issuer database 201B in association with constituent's account, and posting of the flagged debit will be deferred pending settlement of the debit.

In the meantime, a claim is filed with the benefit provider regarding the service in process 70. This procedure can be done automatically by a computer process in the card issuer's computer system, once the charge has been flagged.

In process 80, settlement of the flagged debit could be made by payment from the benefit provider directly to the credit card account of the cardholder, at which time the flagged charge is removed from the cardholder's account in process 90. Alternatively, in process 100, the benefit provider denies the claim and the debit is posted to the cardholder's account in process 120.

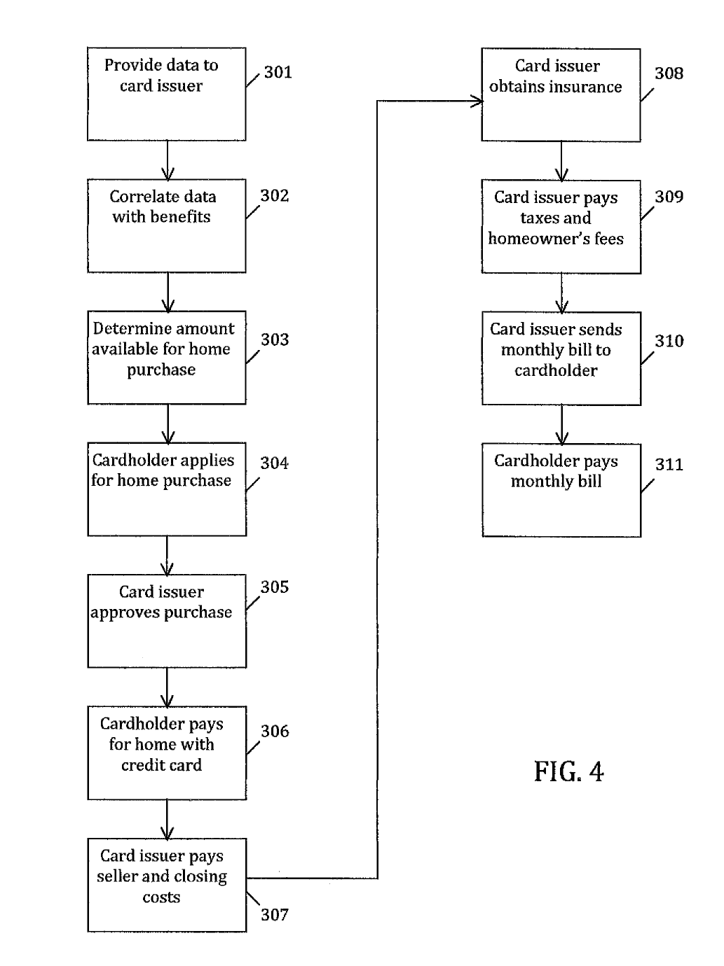

A flow chart of a home purchase in accordance with the invention is shown in FIG. 4. In step 301, the cardholder 201 provides the necessary financial and personal data to card issuer 200. This data includes name, address, employment, income, social security number, date of birth and eligibility for various government benefits and private benefits. In step 302, card issuer 200 correlates this data with data it keeps regarding benefits, to flag any benefits that cardholder 201 may be eligible for in future purchases. In step 303, the card issuer 200 also determines, based on a database of home purchase prices, taxes, and insurance rates, how much of a home the cardholder 201 can purchase. The processor 202 calculates the total cost of a home, estimated taxes, insurance, closing costs and other fees, and turns this into a maximum monthly payment amount. This is the maximum monthly payment that the cardholder can qualify for, based on the cardholder's income. In step 303, the cardholder 201 applies to the card issuer 200 for approval to purchase a home. Cardholder 201 submits the sale price, taxes, closing costs, and all other fees to the card issuer for calculation of a monthly payment. If the monthly cost of the applied-for home is less than the maximum monthly cost calculated by the processor, the card issuer 200 approves of the sale. The cardholder then uses the credit card to pay for the home in step 306.

In the purchase in step 307, the card issuer 200 pays the seller, the realtor and any other party the sale prices and fees. In step 308, the card issuer obtains homeowner's insurance as well as title insurance and any other necessary insurance related to the purchase of the home. Card issuer 200 also contracts to pay homeowner's fees and taxes with the local government and homeowner's association in step 309. In step 310, the card issuer 200 sends a monthly bill to the cardholder 201, who pays it in step 311. In the situation illustrated above, if the cardholder is eligible for various benefits that might change the terms of the sale, the card issuer takes these into account when calculating the monthly fee. For example, if the cardholder is a veteran, he or she may be eligible for a VA loan in which a down payment is not required and is guaranteed by the government. In this situation, the card issuer finances 100% of the purchase price, knowing that the down payment will be guaranteed by the government. The card issuer also finances the closing costs as part of the purchase price in the case of such a VA loan.

Various embodiments of the present invention provide a benefit credit card offered by a card issuer under an agreement with the government or other benefit providers. These embodiments therefore allow the constituent to purchase a home without providing out-of-pocket cash and obtaining the maximum benefits due to the cardholder.

The card can provide information on each credit card billing statement that provides personalized information regarding the payments made to various entities on behalf of the cardholder, the amount of debt left on the account, and certain other relevant financial data.

The present invention may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof. In a typical embodiment of the present invention, predominantly all of the described logic is implemented as a set of computer program instructions that is converted into a computer executable form, stored as such in a computer readable medium, and executed by a microprocessor under the control of an operating system.

Computer program logic implementing all or part of the functionality previously described herein may be embodied in various forms, including, but in no way limited to, a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies (e.g., Bluetooth), networking technologies, and internetworking technologies. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), or other memory device. The programmable logic may be fixed in a signal that is transmittable to a computer using any of various communication technologies, including, but in no way limited to, analog technologies, digital technologies, optical technologies, wireless technologies (e.g., Bluetooth), networking technologies, and internetworking technologies. The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

The embodiments of the invention described above are intended to be merely exemplary; numerous variations and modifications will be apparent to those skilled in the art. The present invention may be embodied in other specific forms without departing from the true scope of the invention. Any references to the “invention” are intended to refer to exemplary embodiments of the invention and should not be construed to refer to all embodiments of the invention unless the context otherwise requires. The described embodiments are to be considered in all respects only as illustrative and not restrictive. All such variations and modifications are intended to be within the scope of the present invention as defined in any appended claims.

What is claimed is:

1. A computerized method for providing credit card services by a card issuer, such method being of the type employing computerized processing of a stream of incoming merchant charges to be posted and stored as debits to a cardholder's account and to generate a bill of the posted charges on a periodic basis to the cardholder, wherein the improvement operates in connection with benefits provided to the cardholder by an entity, the cardholder having an account with the card issuer, the method comprising:
storing, in association with the account, data associated with the cardholder, said data including eligibility for government benefits and financial information about the cardholder;
processing incoming merchant charges to be posted to the account to flag any charge identified as pertaining to a covered charge by the associated data and to store such charge as flagged;
filing a claim with the benefit provider for the flagged charge; and
deferring billing of any flagged charge, pending settlement of such flagged charge under an arrangement with the benefit provider.

2. A method according to claim 1, wherein settlement of each flagged charge comprises using a settlement computer process and crediting of the account of the cardholder with an amount corresponding to such flagged charge when the benefit provider pays the flagged charge to the cardholder's account.

3. A method according to claim 1, wherein processing incoming charges to be posted to the account to flag any charge identified as pertaining to a covered charge further includes determining whether any such charge includes a portion that is not subject to benefit reimbursement, and in such case: flagging only an amount of such charge excluding the portion; and separately processing the portion.

4. A method according to claim 3, wherein separately processing the portion includes posting the portion for current billing on the account of the policyholder.

5. The method according to claim 1, wherein the step of filing a claim occurs automatically via a computer of the card issuer as soon as a charge is flagged.

6. A computerized method for providing credit card services by a card issuer, such method being of the type employing computerized processing of a stream of incoming merchant charges to be posted and stored as debits to a cardholder's account and to generate a bill of the posted charges on a periodic basis to the cardholder, wherein the method operates in connection with benefits provided to the cardholder by an entity, the cardholder having an account with the card issuer, the method comprising:
storing, in association with the account, data associated with the cardholder, said data including identification of the cardholder, financial data of the cardholder and eligibility for government benefits of the cardholder;
storing data regarding benefits available to eligible cardholders;
storing data regarding home prices, taxes, and home insurance;
calculating via a processor of the card issuer a maximum monthly payment of the cardholder based on data provided by the cardholder;
receiving from a cardholder an inquiry regarding a purchase of a home by the cardholder;
calculating via the processor a monthly payment for the purchase of the home based on the price provided by the cardholder and data from the second database;
approving of the purchase when the calculated monthly payment is less than the calculated maximum monthly payment;
receiving a charge from the cardholder for payment of the home; and
paying the charge to a seller.

7. The method according to claim 6, further comprising;
automatically sending monthly invoices to the cardholder for payment of the charges incurred by the cardholder, said invoices listing the monthly payment required by the card issuer.

8. The method according to claim 7, further comprising:
obtaining homeowner's insurance; and
including the cost of the homeowner's insurance in the monthly payment of the cardholder.

9. The method according to claim 7, further comprising comparing the cardholder's personal information with data about benefits to determine the cardholder's eligibility for benefits, and applying the benefits to the account of the cardholder.
